(19) United States
(12) Patent Application Publication
(10) Pub. No.: US 2015/0055872 A1
(43) Pub. Date: Feb. 26, 2015

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Kohshiro INOMATA, Kanagawa (JP)

(73) Assignee: FUJI XEROX CO., LTD., Tokyo (JP)

(21) Appl. No.: 14/295,761

(22) Filed: Jun. 4, 2014

(30) Foreign Application Priority Data
Aug. 23, 2013 (JP) 2013-173798

(51) Int. Cl. G06T 11/60; G06K 9/46

(52) U.S. Cl. CPC G06T 11/60; G06K 9/46; G06K 2009/4666
USPC 382/195

(57) ABSTRACT

An information processing apparatus includes a detector that detects a symbol image representing a symbol from content including an image, a determining unit that determines, on the basis of detail of image processing that changes a display form of the content, a display form of the symbol image in the content subjected to the image processing, and an addition indicating unit that indicates addition of the symbol image in the display form determined by the determining unit to the content subjected to the image processing.

### CROSS-REFERENCE TO RELATED APPLICATIONS

This application is based on and claims priority under 35 USC 119 from Japanese Patent Application No. 2013-173798 filed Aug. 23, 2013.

### BACKGROUND

### Technical Field

The present invention relates to an information processing apparatus, an information processing method, and a non-transitory computer readable medium.

### SUMMARY

According to an aspect of the invention, there is provided an information processing apparatus including: a detector that detects a symbol image representing a symbol, from content including an image; a determining unit that determines, on the basis of detail of image processing that changes a display form of the content, a display form of the symbol image in the content subjected to the image processing; and an addition indicating unit that indicates addition of the symbol image in the display form determined by the determining unit to the content subjected to the image processing.

### BRIEF DESCRIPTION OF THE DRAWINGS

Exemplary embodiments of the present invention will be described in detail based on the following figures, wherein:

FIG. 1 illustrates an example of the overall configuration of an information processing system according to a first exemplary embodiment;

FIG. 2 illustrates an example of the hardware configuration of an information processing apparatus;

FIG. 3 illustrates an example of the functional configuration of the information processing apparatus;

FIG. 4 illustrates an example of a reference table;

FIG. 5 illustrates an example of the position and size of a symbol image;

FIG. 6 illustrates an example of content with a symbol image removed;

FIG. 7 illustrates an example of a removal area whose position and size are changed;

FIGS. 8A through 8C illustrate examples in which display condition that a symbol image satisfies is changed;

FIG. 9 illustrates an example of a symbol image displayed in a determined display form;

FIG. 10 is a flowchart illustrating an example of an operation of display processing performed by the information processing apparatus;

FIG. 11 illustrates an example of the functional configuration of an information processing apparatus according to a second exemplary embodiment;

FIGS. 12A through 12C illustrate an example of a display form determined by a determining unit;

FIGS. 13A through 13C illustrate other examples of a display form determined by a determining unit;

FIGS. 14A and 14B illustrate an example of a gap area;

FIGS. 15A through 15D illustrate a method of checking the detail of image processing using a check image; and

FIG. 16 illustrates an example of the functional configuration of an information processing apparatus according to a variation.

### DETAILED DESCRIPTION

### (1) First Exemplary Embodiment

### (1-1) Overall Configuration

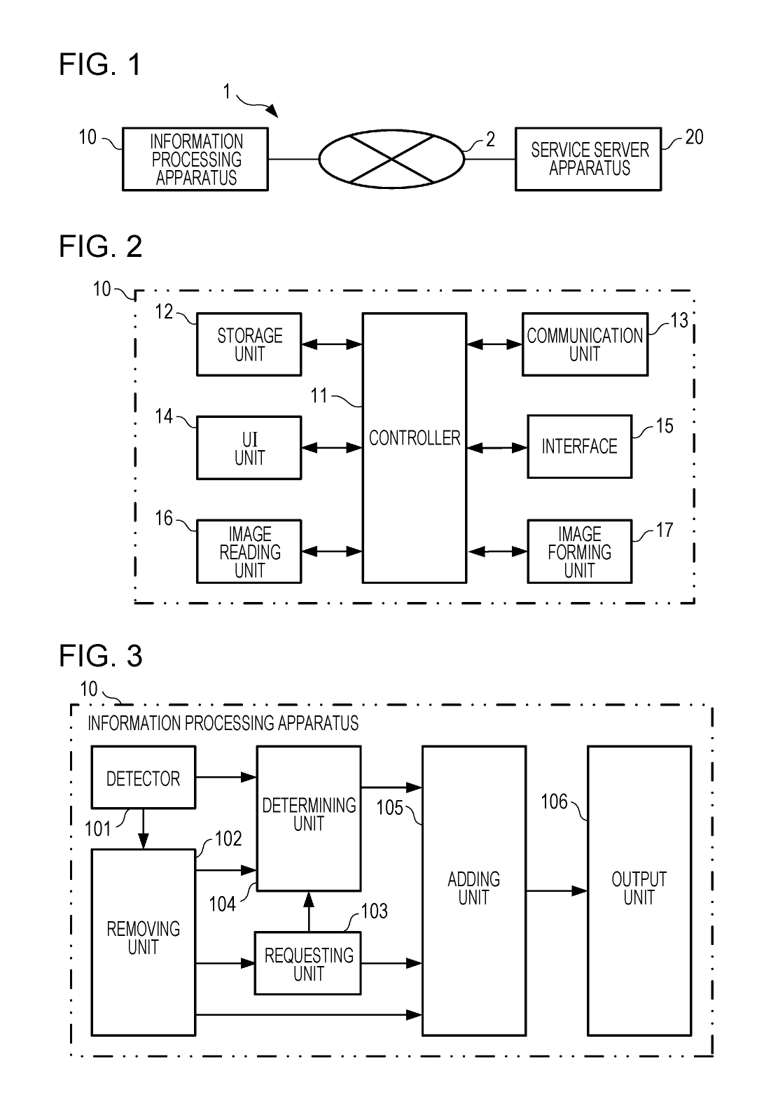

FIG. 1 illustrates an example of the overall configuration of an information processing system according to a first exemplary embodiment. In FIG. 1, an information processing system 1 is illustrated that includes a network 2, an information processing apparatus 10, and a service server apparatus 20. The network 2 is a system that includes the Internet or the like and performs communications, and mediates data exchange between apparatuses connected to the system. In the example of FIG. 1, the information processing apparatus 10 and the service server apparatus 20 are connected to the network 2.

The service server apparatus 20 is an apparatus that provides an image processing service that performs predetermined processing on content including an image. Examples of content on which processing is performed include not only photographs and illustrations, but also documents and materials containing images. The service server apparatus 20 performs, on such content, processing such as density conversion for converting the tone and color, image enhancement and smoothing, space filtering for contour extraction, and geometric transformation for changing the image size and tilt. When such processing is performed on the content, the state and condition, that is, the display form of the content after the processing are changed from those before the processing. That is, the service server apparatus 20 performs processing (hereinafter referred to as “image processing”) that changes the display form of content.

Although image processing services are provided by one service server apparatus 20 in the example of FIG. 1, the image processing services may be provided in the form of so-called cloud services. In this case, image processing is not always performed by a specific apparatus. However, it is only necessary that a function for performing image processing on content including an image be realized. The service server apparatus 20 transmits result data indicating results of the image processing, that is, the content subjected to image processing to an apparatus which requested the image processing.

The information processing apparatus 10 is an apparatus that requests the service server apparatus 20 to perform image processing on content, and outputs results, that is, the content subjected to image processing. The information processing apparatus 10 is operated by the user, and transmits content to be subjected to image processing and request data for requesting image processing on the content to the service server apparatus 20. When the service server apparatus 20 transmits, as result data, the content on which image processing is performed on the basis of the received request data, the information processing apparatus 10 outputs the result data, that is, the content subjected to image processing, on a medium such as paper, for example. In this way, in the information processing system 1, an image processing service that performs image processing on content is provided to the user.

### (1-2) Hardware Configuration

FIG. 2 illustrates an example of the hardware configuration of the information processing apparatus 10. The information processing apparatus 10 is a computer that includes a controller 11, a storage unit 12, a communication unit 13, a user interface (UI) unit 14, an interface 15, an image reading unit 16, and an image forming unit 17. The controller 11 includes a central processing unit (CPU), a read only memory (ROM), a random access memory (RAM), and a real-time clock. The CPU controls each unit by executing programs stored in the ROM and the storage unit 12 while using the RAM as a work area. The real-time clock calculates the current date and time and transmits the calculated current date and time to the CPU. The storage unit 12 includes a hard disk, and stores data and programs used for control by the controller 11, and image data.

The communication unit 13 includes a communication circuit for performing communications, and transmits data to and receives data from the service server apparatus 20 through the network 2. The communication unit 13 supplies received reception data to the controller 11. The UI unit 14 includes a display screen and a touch panel superimposed on the display screen, and is configured to receive an operation from the user, and display an image. The UI unit 14 supplies operation data corresponding to the received operation of the user to the controller 11, so that the controller 11 performs processing corresponding to the operation data. The interface 15 is an interface including a port for inserting a universal serial bus (USB) device, and supplies the controller 11 with supply data supplied from the USB device inserted in the port. The image reading unit 16 is a scanner, for example, and is configured to optically read the image of the content formed on a medium such as paper, and supplies image data representing the read image to the controller 11. The image forming unit 17 is a unit for forming an image on a medium such as paper, and forms an image on paper with toners of four colors of yellow (Y), magenta (M), cyan (C), and black (K), using an electrophotographic system, for example.

### (1-3) Functional Configuration

The information processing apparatus 10 having the above-described hardware configuration makes a request for image processing and outputs content subjected to image processing. There are cases in which the content for which image processing is requested contains a symbol image representing a symbol. The symbol image is a so-called logo or badge (emblem) used for representing, as a symbol, a company name, group name, organization name (such as police), occupation (such as lawyer), product name, service name, and the like, for example. Some symbol images are required to be displayed in a predetermined display form. For example, the color and size of logos of companies and services are often predetermined. The information processing apparatus 10 performs processing (hereinafter referred to as “display processing”) for displaying such a symbol image in a required display form. The controller 11 controls each unit by executing a program for performing display processing, and thus realizes functions described below.

FIG. 3 illustrates an example of the functional configuration of the information processing apparatus 10. The information processing apparatus 10 includes a detector 101, a removing unit 102, a requesting unit 103, a determining unit 104, an adding unit 105, and an output unit 106.

### (1-3-1) Detector 101

The detector 101 is an example of a unit that detects a symbol image representing a symbol, from content including an image. Some symbol images are required to be displayed in a predetermined display form in order to maintain a constant impression of the symbol, for example. The predetermined display form refers to the font, color, and size of text, and the shape, color, and size of graphics, and the like, for example. The display form is often predetermined for each condition (hereinafter referred to as a “display condition”) such as, for example, the size and background color, that a symbol image to be displayed satisfies.

More specifically, in the case where the symbol image is a square, if there are a display condition specifying that the length of each side is 1 cm or greater and less than 3 cm and a display condition specifying that the length of each side is 3 cm or greater and less than 5 cm, the shape of the symbol image corresponding to each size is predetermined for each display condition. In other words, if the display conditions are the same, then symbol images displayed in content are the same. Accordingly, if a symbol image serving as a reference (hereinafter referred to as a “reference symbol image”) that is displayed in a display form required by a certain display condition is prepared, it is possible to display a symbol image in a required display form by enlarging or reducing the reference symbol image within the range of the display condition. The detector 101 stores a reference table in which a reference symbol image and a display condition that requires the display form of the reference symbol image are associated with each other.

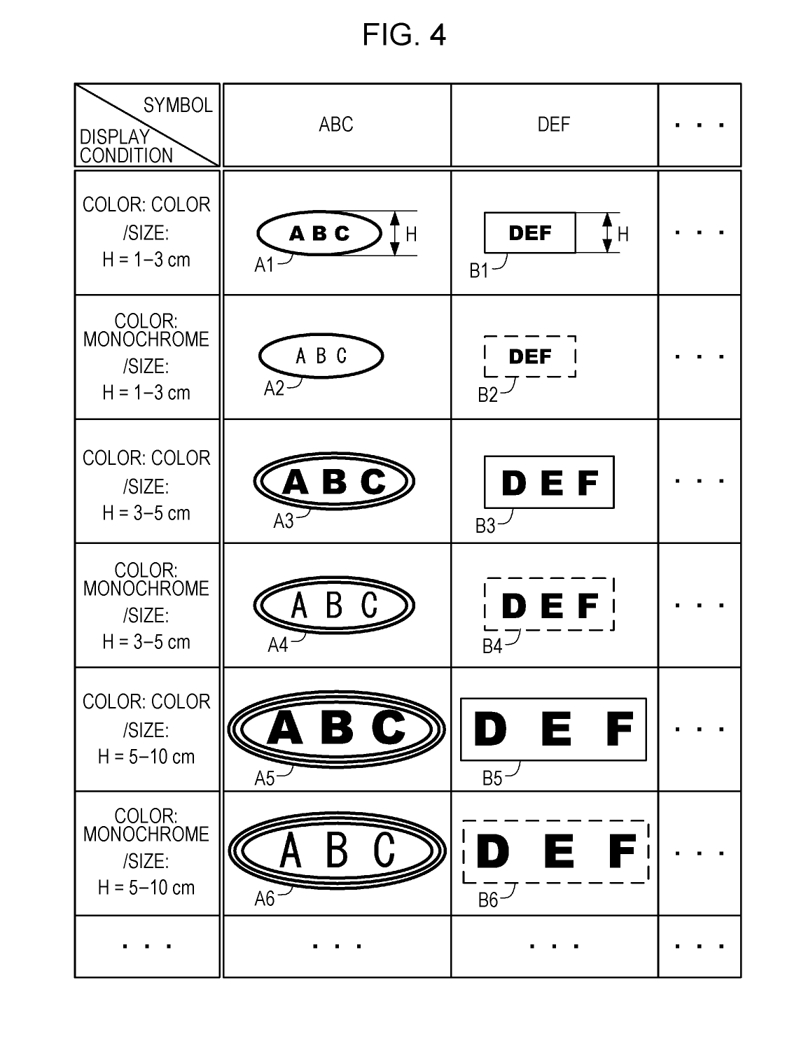

FIG. 4 illustrates an example of a reference table. This example shows reference symbol images A1 through A6 and B1 through B6 for the case of displaying symbols “ABC” and “DEF” under the following display conditions: “color: color/size: H=1-3 cm”; “color: monochrome/size: H=1-3 cm”; “color: color/size: H=3-5 cm”; “color: monochrome/size: H=3-5 cm”; “color: color/size: H=5-10 cm”; and “color: monochrome/size: H=5-10 cm”. In FIG. 4, “H=1-3 cm” indicates that the height of the reference symbol image is 1 cm or greater and less than 3 cm. Note that display forms of the respective reference symbols are determined so as to have the same aspect ratio.

In the case of the symbol “ABC”, the display forms are determined as follows: if the image is in color, the symbol is displayed in a bold font; if the image is monochrome, the symbol is displayed in a normal font; if the size is H=1-3 cm, the symbol is surrounded by a single-line ellipse; if the size is H=3-5 cm, the symbol is surrounded by a double-line ellipse; and if the size is H=5-10 cm, the symbol is surrounded by a triple-line ellipse. In the case of the symbol “DEF”, the display form is determined as follows: if the image is in color, the symbol is surrounded by a solid rectangle; if the image is monochrome, the symbol is surrounded by a dashed rectangle; and the character spacing increases as the height of the reference symbol image increases.

The content to be subjected to detection is transmitted from a terminal such as a smartphone and is supplied through the communication unit 13; is supplied through the interface 15 from a USB device; or is supplied from the image reading unit 16 that has read a medium such as paper, for example. When the content to be subjected to image processing is specified by an operation of the user, the detector 101 determines whether an image that matches any of the reference symbol images contained in the reference table, throughout the specified content. The detector 101 performs this determination using a known pattern matching technique. If a matching image is determined to be present, the detector 101 detects the image as a symbol image. The detector 101 supplies symbol image data indicating the position and size of the detected symbol image and the reference symbol image that matches the detected symbol image to both the removing unit 102 and the determining unit 104.

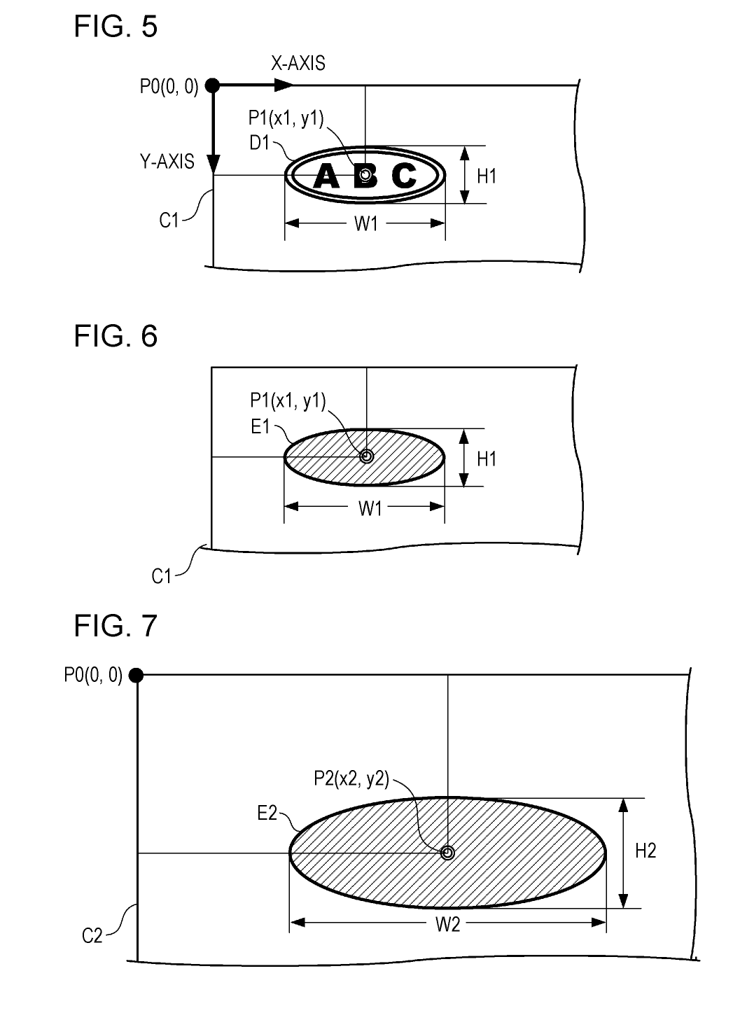

FIG. 5 illustrates an example of the position and size of a symbol image. In FIG. 5, a symbol image D1 is shown in a rectangular content C1. The detector 101 expresses the position of an arbitrary point on the content C1 in coordinates in a coordinate system in which a corner P0 in FIG. 5 is defined as the origin (0, 0) and the sides in contact with the corner are defined as the X-axis and Y-axis. Further, the detector 101 expresses the size of a symbol image with the length along the Y-axis as the height and the length along the X-axis as the width. In this example, the detector 101 supplies symbol image data indicating the coordinates of a center of gravity P1 of the symbol image D1 (x1, y1) as the position of the symbol image, and indicating a height H1 and a width W1 of the symbol image D1 as the size of the symbol image.

### (1-3-2) Removing Unit 102

The removing unit 102 is an example of a unit that removes the symbol image detected by the detector 101 from the content when image processing is performed. For example, the removing unit 102 removes the detected symbol image by superimposing, on the position of the symbol image indicated by the symbol image data supplied from the detector 101, a single-color image (such as black and white) having a size equal to the size indicated by the symbol image data. Note that the method of removing the symbol image is not limited thereto, and the removing unit 102 may remove the symbol image, whose position and size are indicated by the symbol image data, by performing image processing that paints out the symbol image with a certain color, for example.

FIG. 6 illustrates an example of content with a symbol image removed. In this example, the symbol image D1 of FIG. 5 is removed from the content C1, and an area (hereinafter referred to as a “removal area”) E1 in which the symbol image D1 was displayed is illustrated. In this example, the position and size of the removal area E1 are the same as those of the symbol image D1. Note that the position and size do not have to be the same. For example, the removal area may have the shape of a rectangle surrounding the symbol image. In other words, the removing unit 102 may be any unit as long as the unit is capable of altering the content such that the symbol image is not recognizable. After removing the symbol image, the removing unit 102 supplies the content with the symbol image removed to the requesting unit 103. Further, the removing unit 102 supplies, to the determining unit 104 and the adding unit 105, removal area data indicating the position and size of the removal area (in the example of FIG. 6, the removal area data and the symbol image data contain the same information).

### (1-3-3) Requesting Unit 103

The requesting unit 103 is an example of a unit that requests image processing on content. The requesting unit 103 transmits, to the service server apparatus 20, content supplied from the removing unit 102 and data indicating the detail of image processing on the content selected by an operation of the user, that is, request data for requesting image processing on content. Thus, image processing on the content specified by the user is requested to the service server apparatus 20. After requesting the image processing, the requesting unit 103 supplies the request data indicating the detail of image processing to the determining unit 104 and the adding unit 105.

Note that the service server apparatus 20 to which image processing is requested performs the requested image processing on the content, and transmits the result data to the information processing apparatus 10. The thus transmitted result data is supplied to the adding unit 105.

### (1-3-4) Determining Unit 104

The determining unit 104 is an example of a unit that determines, on the basis of the detail of image processing that changes the display form of content, a display form of a symbol image in the content subjected to the image processing. In the case where image processing is performed on content, the position, size, shape, and so on of a removal area may be changed. The following describes how the position and size of the removal area E1 is changed in the case where image processing for “enlarging twice around the corner P0” is performed on the content C1 of FIG. 6, with reference to FIG. 7.

FIG. 7 illustrates an example of a removal area whose position and size are changed. In FIG. 7, a removal area E2 whose size is twice the size of the removal area E1 of FIG. 6 (the height is H1×2=H2, and the width is W1×2=W2). The coordinates (x2, y2) of a center of gravity P2 of the removal area E2 are twice the X-coordinate and Y-coordinate of the center of gravity P1 (x1, y1) of the removal area E1. The determining unit 104 is supplied with removal area data indicating the position and size of a removal area from the removing unit 102, and is supplied with request data indicating “binarizing” and “enlarging twice around the corner P0” as the detail of image processing from the requesting unit 103. The determining unit 104 identifies the size (H2 and W2) and the position (coordinates of P2) of the removal area E2, on the basis of the supplied removal area data and request data.

Further, when image processing that is performed on the content is also performed on the symbol image, its size and color are changed. Thus, for example, the display condition as shown in FIG. 4 may be changed.

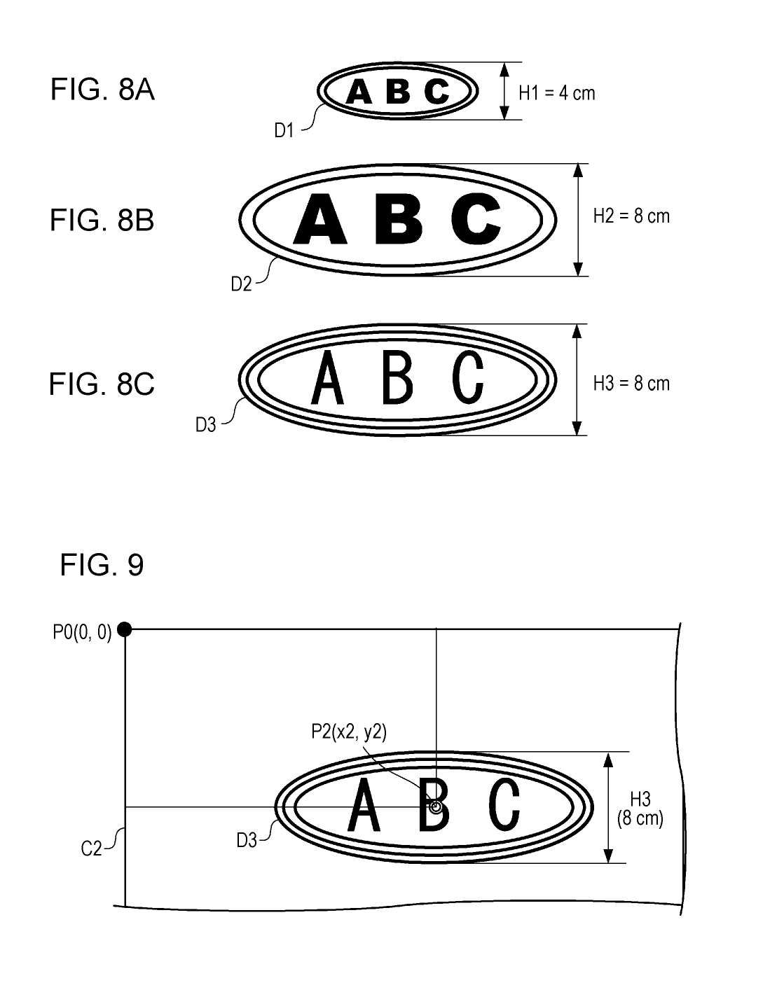

FIGS. 8A through 8C illustrate examples in which the display condition that a symbol image satisfies is changed. In FIG. 8A, the symbol image D1 of FIG. 5 is illustrated. In the examples of FIG. 8A, the symbol image D1 is in color, and the height H1 is 4 cm. That is, the symbol image D1 satisfies the display condition “color: color/size: H=3-5 cm” of FIG. 4. Further, in the examples of FIGS. 8A through 8C, image processing for “binarizing” is performed in addition to “enlarging twice around the corner P0”.

In FIG. 8B, a symbol image D2 is illustrated as the result of performing this image processing on the symbol image D1. The symbol image D2 is monochrome and the height H2 is 8 cm, and thus satisfies the condition “color: monochrome/size: H=5-10 cm”. In FIG. 8C, a symbol image D3 is illustrated which is obtained by setting a height H3 of the reference symbol image A6 that satisfies this display condition to 8 cm. In this manner, when the symbol “ABC” is displayed in a display form that is required in the case where the display condition “color: monochrome/size: H=5-10 cm” is satisfied, the symbol “ABC” is not the symbol image D2, but is the symbol image D3. That is, although the symbol image D1 was displayed in the required display form, the required display form is not maintained when the symbol image D1 is changed to the symbol image D2 by the image processing.

In addition to the above data, the determining unit 104 is supplied with the reference symbol image A3 that matches the detected symbol image D1 and symbol image data indicating the height of the symbol image D1 of H1=4 cm, from the detector 101. In the examples of FIGS. 8A through 8C, the determining unit 104 identifies, on the basis of the supplied data, the height H3=8 cm as the size of the symbol image in the case where image processing of “binarizing” and “enlarging twice around the corner P0” is performed on the symbol image D1, and identifies “color: monochrome/size: H=5-10 cm” as the display condition that is satisfied in this case.

The determining unit 104 determines a display form in which the symbol “ABC” represented by the supplied reference symbol image A3 is displayed with the identified size of the symbol image, that is, “height H3=8 cm”, at the identified position of the removal area, that is, “the position that locates the center of gravity at P2 (x2, y2)”, using the “reference symbol image A6” displayed under the identified display condition.

FIG. 9 illustrates an example of a symbol image displayed in a determined display form. In FIG. 9, the symbol image D3 of FIG. 8C is displayed at the position that locates the center of gravity at P2 (x2, y2) of content C2 of FIG. 7. The determining unit 104 supplies display form data indicating the thus determined display form to the adding unit 105.

### (1-3-5) Adding Unit 105

The adding unit 105 is an example of a unit that adds a symbol image in a display form determined by the determining unit 104 to content subjected to image processing. As mentioned above, the adding unit 105 is supplied with the result data, that is, content subjected to image processing, from the service server apparatus 20. The adding unit 105 adds, to this content, a symbol image in a display form indicated by the display form data that is supplied from the determining unit 104. The adding unit 105 places the symbol image D3 at a position that locates the center of gravity at P2 (x2, y2) of the content C2 as shown in FIG. 9, for example. Thus, the symbol image D3 is superimposed on the removal area E2. In this example, the removal area E2 and the symbol image D3 have the same size. Therefore, as shown in FIG. 9, only the symbol image D3 is displayed in the content C2. The adding unit 105 adds the symbol image to the removal area in the manner described above, and supplies to the output unit 106 the content to which the symbol image is added.

### (1-3-6) Output Unit 106

The output unit 106 is an example of a unit that outputs content to which a symbol image is added by the adding unit 105. For example, the output unit 106 outputs content supplied from the adding unit 105, to a medium transported to the image forming unit 17 of FIG. 2. The output unit 106 may output the content to the registered or entered address of the user (mail address, social networking service (SNS) account, or the like).

### (1-4) Operation

The information processing apparatus 10 having the above-described configuration performs the above-described display processing.

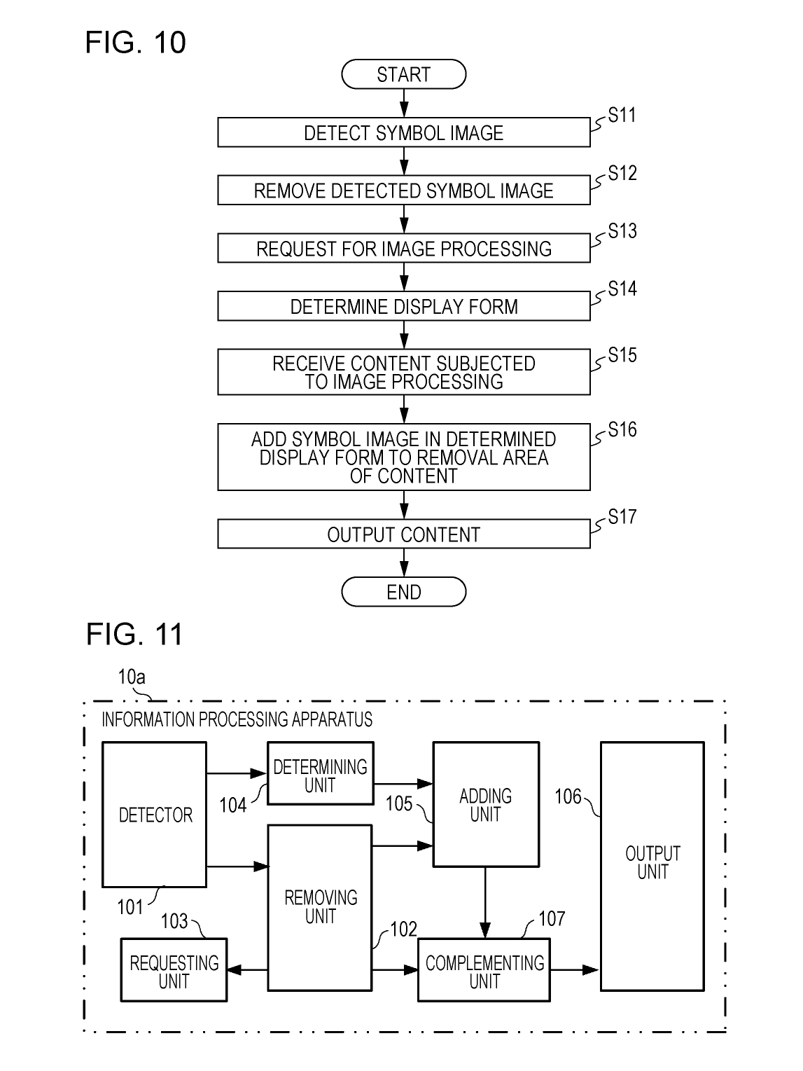

FIG. 10 is a flowchart illustrating an example of an operation of display processing performed by the information processing apparatus 10. First, the information processing apparatus 10 detects a symbol image from content (step S11). The operation of step S11 is performed by the detector 101. Then, the information processing apparatus 10 removes the detected symbol image from the content (step S12), and requests the service server apparatus 20 to perform image processing on the content (step S13). The operation of step S12 is performed by the removing unit 102, and the operation of step S13 is performed by the requesting unit 103.

Subsequently, the information processing apparatus 10 determines a display form of the symbol image on the basis of the detail of image processing (step S14). The operation of step S14 is performed by the determining unit 104. Then, the information processing apparatus 10 receives the content from the service server apparatus 20 (step S15), and adds the symbol image in the display form determined in step S14 to the received content, that is, the content subjected to image processing (step S16). The operations of steps S15 and S16 are performed by the adding unit 105. The information processing apparatus 10 outputs the content to which the symbol image is added (step S17), and thus the display processing ends. The operation of step S17 is performed by the output unit 106.

When image processing is performed on the content, the display condition may be changed as in the case of the symbol image D2 of FIG. 8B, for example. In this case, in this exemplary embodiment, a display form (for example, the display form of FIG. 9) required by the changed display condition is determined on the basis of the detail of image processing. Note that in the case where the detail of image processing is determined in accordance with the detail of service selected by the user or a uniform resource locator (URL) that issued an instruction, the display form of the symbol may be determined in accordance with the detail of the service or the URL. In any case, even if image processing is performed on the content, the display form required for the symbol image is maintained.

Further, in this exemplary embodiment, as illustrated in FIG. 6, the detected symbol image is removed as shown in FIG. 6. Accordingly, it is possible to prevent symbol images from being displayed one over the other in the content on which image processing is performed and to which a symbol image is added.

Further, in this exemplary embodiment, as illustrated in FIG. 9, the symbol image is displayed at the position of the removal area after image processing. Accordingly, compared to the case where the display form is determined without using the position of the removal area after image processing, the symbol image is less likely to overlap the content.

### (2) Second Exemplary Embodiment

The following description of a second exemplary embodiment of the present invention mainly describes the differences from the first exemplary embodiment. In the first exemplary embodiment, a symbol image in a display form that is determined on the basis of the detail of image processing is added to content subjected to image processing. In the second exemplary embodiment, a symbol image having the same attribute as a symbol image in the content detected by the detector 101 is added to content subjected to image processing.

(2-1) Functional Configuration

FIG. 11 illustrates an example of the functional configuration of an information processing apparatus according to the second exemplary embodiment. In this example, an information processing apparatus 10a is illustrated that includes a complementing unit 107 in addition to the units shown in FIG. 3. In this exemplary embodiment, a removing unit 102 supplies removal area data to the complementing unit 107 as well, while a requesting unit 103 does not supply request data to other units. Further, the adding unit 105 supplies to the complementing unit 107 content to which a symbol image is added.

(2-1-1) Determining Unit 104

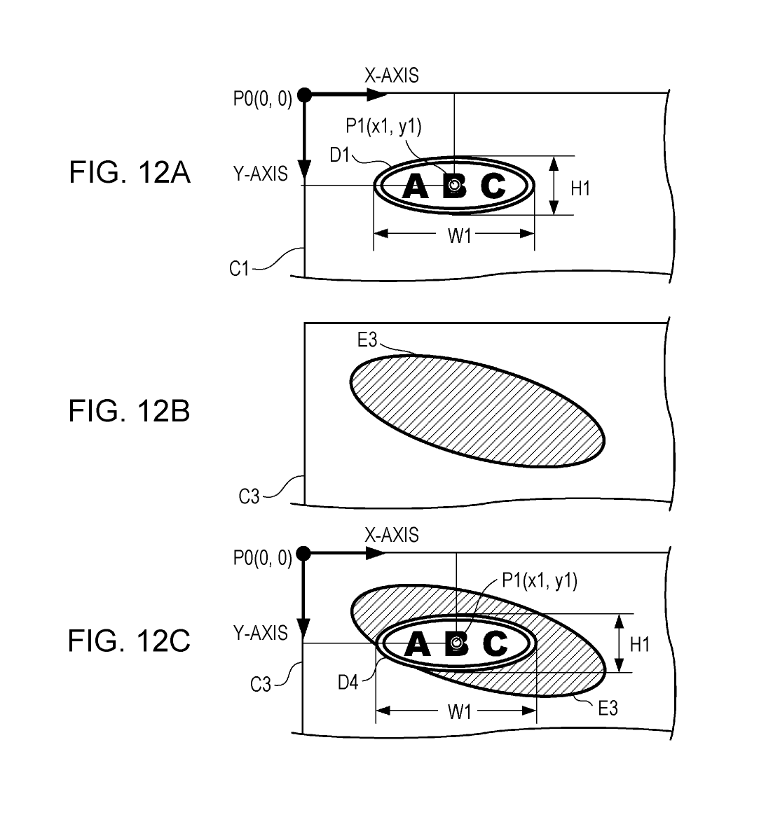

A determining unit 104 determines a display form of a symbol image in content subjected to image processing such that the symbol image in the content subjected to image processing has the same attributes (hereinafter referred to as the “image attribute”) as a symbol image detected by a detector 101. Examples of image attributes include the position, size, and color of the symbol image, and the symbol represented by the symbol image. In this case, the determining unit 104 determines a display form on the basis of symbol image data and a reference symbol image supplied from the detector 101. The symbol image data indicates the position and size of the symbol image. The reference symbol image indicates the color of the detected symbol image and the symbol represented by the symbol image. That is, these pieces of data indicate the image attributes. The display form determined by the determining unit 104 on the basis of the image attributes will be described with reference to FIGS. 12A through 12C.

FIGS. 12A through 12C illustrate an example of a display form determined by the determining unit 104. In FIG. 12A, the content C1 and the symbol image D1 of FIG. 5 are illustrated. In FIG. 12B, content C3 is shown in which a removal area E3 is displayed. The content C3 is obtained by performing image processing on the content C1 with the symbol image D1 removed. The removal area E3 is larger than the removal are E1 of FIG. 6, and is tilted. The determining unit 104 determines, as a symbol image to be added, a symbol image D4 all of whose image attributes are the same as the image attributes of the symbol image D1, which are the position (the coordinates of the center of gravity are (x1, y1)), the size (the height is H1), the color (the color of the reference symbol image A3), and the symbol represented by the symbol image (the character string “ABC”), for example. In the examples of FIGS. 12A through 12C, the determining unit 104 determines the display form that displays the symbol image D4 on the basis of the image attributes. In this example, although the symbol image is partially outside the removal area (is not within the removal area) as shown in FIG. 12C, the determining unit 104 determines the display form.

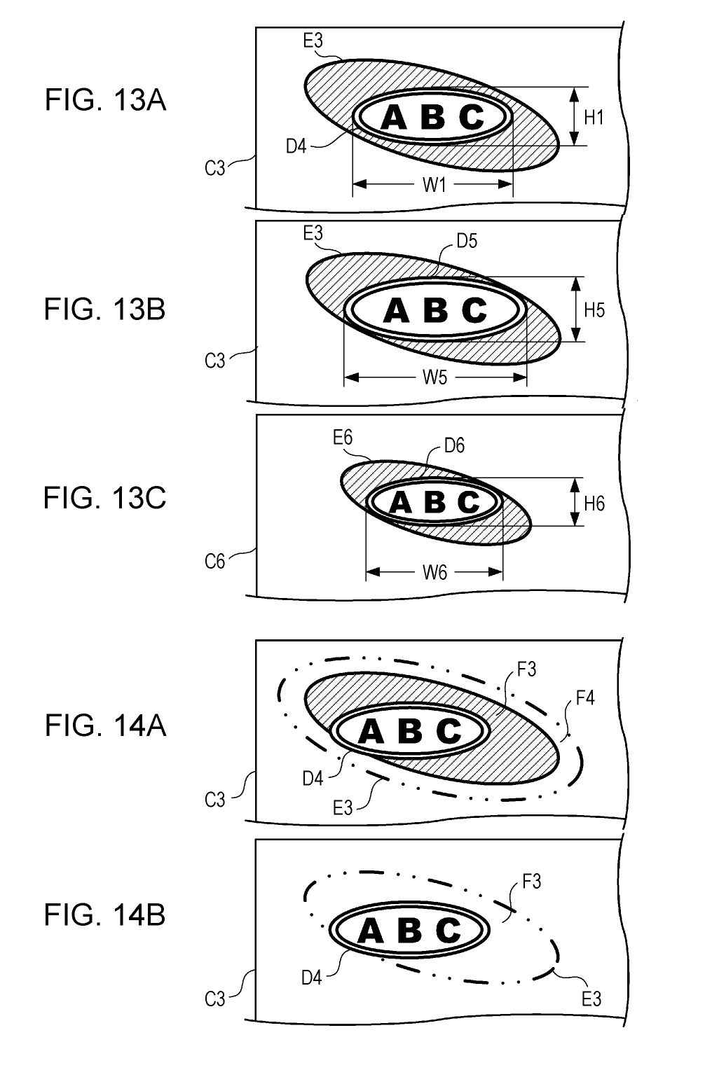

Note that the method by which the determining unit 104 determines a display form on the basis of the image attributes is not limited to that illustrated in FIGS. 12A through 12C. Other methods of determining a display form will be described with reference to FIGS. 13A through 13C.

FIGS. 13A through 13C illustrate other examples of a display form determined by the determining unit 104. In FIG. 13A, the determining unit 104 determines the display form of the symbol image such that the symbol image has the same image attributes except the position of the symbol image (that is, the size, color, and symbol). In this case, the determining unit 104 determines, as a removal area where image formation is performed, an area whose color is the color of the image superimposed on a removal area from which a symbol image is removed by the removing unit 102 (or the color with which the removal area is painted out (this color is hereinafter referred to as a “removal area color”) and whose size is equal to or greater than a certain size, in the content C3, for example. The size of the area may be determined by the number of pixels or the dimension, for example. The determining unit 104 determines the position and size of the removal area in this way, even if the detail of image processing is unknown. The determining unit 104 determines the position of the symbol image D4 such that the center of gravity of the symbol image D4 matches the center of gravity of the removal area E3, on the basis of the thus determined position and size of the removal area E3.

In FIG. 13B, the determining unit 104 determines the display form of the symbol image such that the symbol image has the same image attributes except the position and size of the symbol image (that is, the color and symbol). More specifically, the determining unit 104 determines a display form that displays the symbol image within the removal area where removal is performed by the removing unit 102, by enlarging or reducing the symbol image. In this example, the determining unit 104 determines a display form that displays a symbol image D5 of a height H5 (H5>H1) and a width W5 (W5>W1) within the removal area E3 by enlarging the symbol image D1 of FIG. 12A of the height H1 and the width W1.

While FIG. 13B illustrates an example in which the symbol image is enlarged, FIG. 13C illustrates an example in which the symbol image is reduced. In content C6 of this example, a removal area E6 is displayed. Since image processing different from that performed in the case of the content C3, only a symbol image smaller than the symbol image D4 can be placed within the removal area E6. In this example, the determining unit 104 determines a display form that displays a symbol image D6 of a height H6 (H6<H1) and a width W6 (W6<W1), which is obtained by reducing the symbol image D1, that is, a display form that displays a symbol image within the removal area E6.

In all the above cases, the determining unit 104 determines the display form of the symbol image on the basis of the image attributes (the attributes of the symbol image).

(2-1-2) Complementing Unit 107

The complementing unit 107 is an example of a unit that complements, with an image, the area of a gap (hereinafter referred to as a gap area) between a part of content other than a removal area and a symbol image added by the adding unit 105. In this exemplary embodiment, the complementing unit 107 complements the gap area on the basis of an image around the removal area. As mentioned above, the complementing unit 107 is supplied with removal area data from the removing unit 102, and is supplied with content to which a symbol image is added from the adding unit 105. The complementing unit 107 identifies an area of the above-described removal area color as a gap area, from the removal area that is displayed at the position and with the size of the removal area indicated by the removal area data, in the supplied content.

FIGS. 14A and 14B illustrate an example of a gap area. In FIG. 14A, a part of the removal area E3 of FIG. 12C other than the symbol image D4, that is, a gap area F3, is illustrated. Further, an area (hereinafter referred to as an “adjacent area”) F4 adjacent to the gap area F3 is also illustrated. The complementing unit 107 complements the gap area with an image, by painting out the gap area with the same color as the adjacent area, for example. In FIG. 14B, a gap area F3 is illustrated that is complemented with an image of the same color as the adjacent area F4 by the complementing unit 107. Note that even if the image of the adjacent area F4 is not a single-color image and contains patterns and graphics, the complementing unit 107 may divide the adjacent area F4 into plural segments in the circumferential direction of the outer circumference of the adjacent area F4, and complement the gap area F3 adjacent to the segments by superimposing thereon images respectively duplicated from the divided segments. After performing complement in this way, the complementing unit 107 supplies the complemented content to the output unit 106. The output unit 106 outputs the content complemented with an image by the complementing unit 107.

In this exemplary embodiment, on the basis of the above-described image attributes (the attributes of the symbol image), a symbol image is added to the content as shown, for example, in FIG. 12C regardless of the detail of image processing.

Further, in this exemplary embodiment, a display form that displays a symbol image within a removal area by enlarging or reducing the symbol image.

Further, in this exemplary embodiment, the gap area is complemented with an image.

### (3) Variations

The above-described exemplary embodiments are merely examples of implementation of the present invention, and variations may be made as described below. Further, the above-described exemplary embodiments and the following variations may be implemented in combination as needed.

(3-1) Adding Check Image

In the above-described exemplary embodiments, request data indicating the detail of image processing is supplied from the requesting unit 103. However, the information processing apparatus 10 may check the detail of image processing, using an image (hereinafter referred to as a “check image”) for checking the detail of image processing. In this case, the determining unit 104 of the information processing apparatus 10 adds a check image to content, and checks the detail of image processing on the basis of the check image observed after image processing is performed on the content.

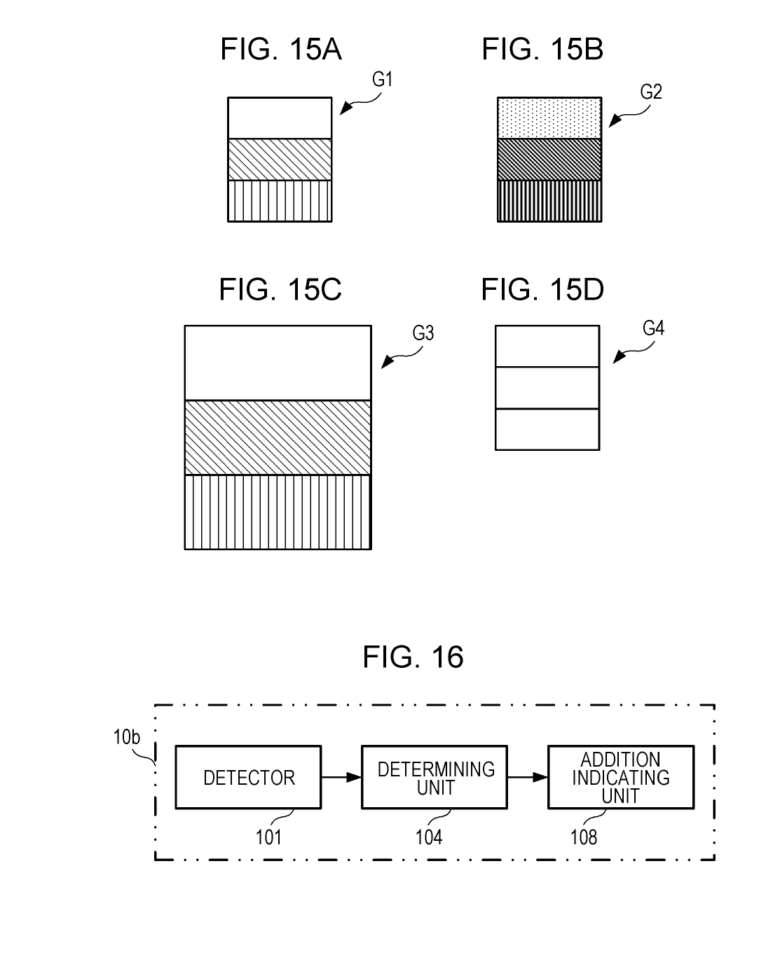

FIGS. 15A through 15D illustrate a method of checking the detail of image processing using a check image. In FIG. 15A, a check image G1 as an example of a check image is illustrated. The check image G1 has the shape of three rectangles of different colors that are connected at the long sides thereof. When the check image G1 is added to the content and image processing is performed on the content, the check image G1 is changed as shown in FIGS. 15B through 15D, for example. In FIG. 15B, a check image G2 is illustrated whose color density of each rectangle is changed by performing density conversion on the check image G1. In FIG. 15C, a check image G3 is illustrated whose size is changed by performing geometric transformation on the check image G1. In FIG. 15D, a check image G4 is illustrated in which only the contour of each rectangle is displayed by applying a space filter to the check image G1.

The determining unit 104 stores the images that display the check images G2, G3, and G4 in association with the corresponding detail of image processing. The determining unit 104 determines that, if any of the check images G2, G3, and G4 is displayed in the content subjected to image processing, the detail of image processing that is stored in association therewith is performed.

The determining unit 104 determines, on the basis of the detail of image processing that is checked in this way, a display form of a symbol image in the content subjected to the image processing. Some symbol images are required to be displayed in a display form corresponding to the background color, for example. If such a symbol image is detected by the detector 101 and the background color is changed by density conversion performed on the content, the determining unit 104 selects and determines a display form that displays a symbol image of the color closest to the changed background color. Further, some symbol images are required to be displayed in a display form corresponding to their size, as in the case of those described in the exemplary embodiments. If such a symbol image is detected by the detector 101 and the size is changed by geometric transformation performed on the content, the determining unit 104 determines a display form corresponding to the changed size.

Further, some symbol images are not allowed to be displayed only with the contour of graphic. In other words, some symbol images are required to be displayed in a display form in which the inside of graphics is always painted out. If such a symbol image is detected by the detector 101 and a space filter as illustrated in FIG. 15D is applied to the content, the determining unit 104 determines a display form that displays the original symbol image that is not subjected to image processing.

The check image may be removed after the symbol image is added. Accordingly, a check image may be added to an area from which a symbol image is removed by the removing unit; a symbol image to be added may be determined by referring to the check image, after image processing; and then a symbol image is added on the check image. If the check image is not covered by the symbol image, complement may be performed by the complementing unit.

Further, the shape of the check image does not have to be fixed, and may be changed in accordance with the shape of the symbol image to be removed. Further, as for the method of determining a symbol image to be added, the most appropriate symbol image may be determined not only on the basis of the check image and the detail of image processing, but also in accordance with the tendency of the entire content subjected to image processing.

(3-2) Adding No Symbol Image

The adding unit 105 does not have to add a symbol image in specific cases. For example, if the content is a photograph, the adding unit 105 does not add a symbol image. In this case, for example, if information called Exchangeable image file format (Exif) is embedded in a file representing the content, the adding unit 105 determines that the content is a photograph, and does not add a symbol image. If Exif is not embedded, the adding unit 105 determines that the content is not a photograph, and adds a symbol image. Note that the method of determining whether the content is a photograph is not limited thereto. For example, the adding unit 105 may determine whether the content is a photograph by analyzing an image contained in the content.

Further, the removing unit 102 may be configured so as not to remove the symbol image if the content is a photograph. Note that, if the content has plural areas including an area displaying a photograph, the adding unit 105 does not have to add a symbol image to the area displaying the photograph. Further, if the content has plural areas including an area displaying a photograph, the removing unit 102 does not have to remove a symbol image in the area displaying the photograph.

For example, there may be a case in which the detector 101 detects a symbol image that is shown as the background of a photograph. In this case, if the symbol image is removed from the content or a symbol image is added after image processing is performed, the symbol image that has been shown in the photograph might be lost. According to this variation, since removal or addition of a symbol image is not performed in the case where the content is a photograph or in the area displaying a photograph, a symbol image in the photograph remains.

(3-3) Updating Symbol Image

The reference symbol images may include one that is not displayed. There may be a symbol image that includes an old symbol image and a new symbol image updated from the old symbol image. For example, this may be the case where the name of a company is changed and the symbol image is changed to a new one. In this case, the detector 101 stores a reference table that stores both a reference symbol image representing an old symbol image that is no longer used, and a reference symbol image representing a new symbol image. Thus, the detector 101 detects both the old symbol image and the new symbol image. If the old symbol image is detected by the detector 101, the determining unit 104 determines a display form of the new symbol image updated from the old symbol image. The adding unit 105 adds the symbol image (that is, the new symbol image) whose display form is determined by the determining unit 104, in the determined display form. Thus, the display form required for the symbol image is maintained, and the old symbol image is updated to the new one.

(3-4) Outputting No Content

The output unit 106 does not have to output content in specific cases. For example, in the case where the symbol image added by the adding unit 105 does not maintain the required display form, the output unit 106 does not output the content to which the symbol image is added. The symbol image does not maintain the required display form in the following case, for example. The symbol image of FIG. 4 representing the symbol “ABC” is not allowed to be displayed with a height less than 1 cm or a height of 10 cm or greater. It is assumed that image processing that enlarges content including this symbol image is performed, so that a display form that displays a symbol image having a height of 10 cm or greater is determined, and such a symbol image is added. In this case, the added symbol image does not maintain the required display form.

Note that, in the above case, the output unit 106 may output inquiry data to the user for inquiring whether to output the content. The inquiry data is text data describing an inquiry, for example, and is output to the UI unit 14 and displayed. Thus, the inquiry is presented to the user, so that the inquiry is made. If the answer provided by the user operation indicates that the user wants to output the content, the output unit 106 outputs the content. If the answer is negative, the output unit 106 does not output the content.

Alternatively, if the number of copies of the content to be output on a medium is less than a predetermined number of copies (for example, two copies), the output unit 106 may output the content by determining that the user wants to output the content for their personal reference; and if the number of copies is equal to or greater than the predetermined number of copies, the output unit 106 may not output the content by determining that the user wants to output the content so as to distribute the content to other people. In this way, even in the above cases, the content is output in accordance with the operation by the user or the number of copies to be output. Accordingly, the inconvenience that the content is not output even in the case where the user is to use the content on their own is avoided.

(3-5) Adding Additional Symbol Image

As mentioned above, the content includes documents and materials. Such content may contain plural images (that is, pages), and a symbol image is displayed on each page. If image processing is performed on such content, the adding unit 105 may add a symbol image also to an image from which no symbol image is detected by the detector 101, among the plural images. For example, it is assumed that, in content having ten images (pages), a symbol image is detected at the right upper corner in nine images, and no symbol image is detected in only one image. In this case, if the adding unit 105 adds the same symbol image at the same position in the nine images, the adding unit 105 adds the same symbol image at the same position in the remaining one image.

Some materials have a symbol image such as logo on each page. When preparing such a material, a page not having a symbol image may be inserted. Then, the appearance is impaired compared to the case where a symbol image is displayed on all the pages. In this variation, the adding unit 105 adds a symbol image in the manner described above, a symbol image is displayed on a page on which no symbol image has been displayed. Thus, the appearance of the content becomes more uniform compared to the case where such addition is not performed.

Note that the adding unit 105 does not have to add a symbol image to the top image in the case where plural images are arranged in order. Thus, in the case where the top image is the cover, it is possible to prevent the appearance from being impaired due to addition of a symbol image to the cover. Further, the adding unit 105 may perform the above-described addition if the percentage of the number of images not having a symbol image to the total number of images is equal to or less than a threshold. The images that do not have a symbol image include images that do not have a symbol image although the images should as described above, and images that should not have a symbol image. The higher the percentage is, the higher the likelihood that the latter case applies is. In the case where the adding unit 105 performs addition on the basis of the threshold, the symbol image is more likely to be added only to the images that should have a symbol image, compared to the case where addition is not performed on the basis of the threshold.

(3-6) Apparatus Performing Image Processing

In the information processing system 1, an apparatus other than the service server apparatus 20 may perform image processing. For example, an external apparatus other than the service server apparatus 20 may perform image processing, or the information processing apparatus 10 may perform image processing on its own. In the latter case, the information processing apparatus 10 includes an image processing unit, and the requesting unit 103 requests the image processing unit to perform image processing.

Further, an external apparatus may make a request for image processing. In this case, if the information processing apparatus 10 determines a display form on the basis of the detail of image processing as described in the first exemplary embodiment, the information processing apparatus 10 receives information indicating the detail of image processing from the external apparatus, for example.

(3-7) Configuration not Having One or More Units

The information processing apparatus does not have to include one or more of the units shown in FIGS. 3 to 11. For example, the information processing apparatus does not have to include the removing unit 102. Accordingly, the information processing apparatus does not remove a symbol image. In this case, for example, the adding unit 105 adds a symbol image so as to cover the original symbol image, so that the original symbol image does not appear in the content subjected to image processing. Further, the information processing apparatus does not have to include the requesting unit 103, and an external apparatus may make a request for image processing, for example. In this case, the information processing apparatus acquires the detail of image processing and the attributes of the symbol image from the external apparatus, and determines a display form on the basis of these pieces of information. Further, the information processing apparatus does not have to include the output unit 106. For example, the information processing apparatus may store therein content to which a symbol image is added, and perform another image processing on the stored content.

Further, the information processing apparatus may instruct an external apparatus to add a symbol image, instead of adding a symbol image on its own.

FIG. 16 illustrates an example of the functional configuration of an information processing apparatus according to this variation. In this example, an information processing apparatus 10b is illustrated that includes a detector 101, a determining unit 104, and an addition indicating unit 108. The addition indicating unit 108 is an example of a unit that indicates addition of a symbol image in a display form determined by the determining unit 104 to content subjected to image processing. In this way, the information processing apparatus only needs to include at least the detector 101, the determining unit 104, and the addition indicating unit 108 (or the adding unit 105). When these units are included, a display form is determined on the basis of the detail of image processing or the attributes of a symbol image as described in the above-described exemplary embodiments. Accordingly, even if image processing is performed on the content, the display form required for the symbol image is maintained. Note that the information processing apparatus may include a removal indicating unit that indicates removal in the manner described above in place of the removing unit 102, and may include a complement indicating unit that indicates complement in the manner described above in place of the complementing unit 107.

(3-8) Complementing Unit 107

The complementing unit 107 may complement a gap area generated in the first exemplary embodiment with an image. For example, if the removal area E2 of FIG. 7 is displayed at an angle as a result of image processing, a gap area is generated. In this case, the complementing unit 107 complements the gap area in the manner described with reference to FIGS. 14A and 14B.

(3-9) Category of Invention

The present invention may be implemented not only as an information processing apparatus and an information processing system provided with an information processing apparatus, but also as an information processing method for realizing processing performed by an information processing apparatus. The term “processing” as used herein refers to, for example, the display processing illustrated in FIG. 10. Further, the present invention may be implemented as a program that causes a computer such as an information processing apparatus to function as the units illustrated in FIG. 3 and other figures. This program may be provided in the form of a recording medium such as an optical disc storing the program, or may be provided by being downloaded and installed in a computer over a network such as the Internet so as to be available.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiment were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a detector that detects a symbol image representing a symbol, from content including an image;
a determining unit that determines, on the basis of detail of image processing that changes a display form of the content, a display form of the symbol image in the content subjected to the image processing; and
an addition indicating unit that indicates addition of the symbol image in the display form determined by the determining unit to the content subjected to the image processing.

2. The information processing apparatus according to claim 1, wherein the determining unit adds a check image for checking detail of image processing to the content, and checks the detail of the image processing on the basis of the check image observed after the image processing is performed on the content.

3. An information processing apparatus comprising:
a detector that detects a symbol image representing a symbol, from content including an image;
a determining unit that determines a display form of the symbol image in the content subjected to image processing that changes a display form of the content, such that the symbol image in the content subjected to the image processing has a same attribute as the symbol image detected by the detector; and
an adding unit that adds the symbol image in the display form determined by the determining unit to the content subjected to the image processing.

4. The information processing apparatus according to claim 1, further comprising:
a removing unit that removes the symbol image detected by the detector from the content when the processing is performed.

5. The information processing apparatus according to claim 3, further comprising:
a removing unit that removes the symbol image detected by the detector from the content when the processing is performed.

6. The information processing apparatus according to claim 4, wherein the determining unit determines a display form that displays the symbol image within a removal area where removal is performed by the removing unit, by enlarging or reducing the symbol image.

7. The information processing apparatus according to claim 5, wherein the determining unit determines a display form that displays the symbol image within a removal area where removal is performed by the removing unit, by enlarging or reducing the symbol image.

8. The information processing apparatus according to claim 5, further comprising:
a complementing unit that complements, with an image, an area of a gap between a part of the content other than the removal area and the symbol image added by the adding unit.

9. The information processing apparatus according to claim 3, wherein if the content is a photograph, the adding unit does not add the symbol image.

10. The information processing apparatus according to claim 3, wherein if the content has a plurality of areas including an area displaying a photograph, the adding unit does not add the symbol image to the area displaying the photograph.

11. The information processing apparatus according to claim 3, wherein:
the symbol image includes an old symbol image and a new symbol image updated from the old symbol image;
if the old symbol image is detected by the detector, the determining unit determines a display form of the new symbol image updated from the old symbol image; and
the adding unit adds the symbol image whose display form is determined by the determining unit in the determined display form.

12. The information processing apparatus according to claim 3, further comprising:
an output unit that outputs the content;
wherein if the symbol image added by the adding unit does not maintain a required display form, the output unit does not output the content to which the symbol image is added.

13. The information processing apparatus according to claim 3, wherein:
the content includes a plurality of images; and
the adding unit adds the symbol image also to an image from which no symbol image is detected by the detector, among the plurality of images.

14. A non-transitory computer readable medium storing a program causing a computer to execute a process for processing information, the process comprising:
detecting a symbol image representing a symbol, from content including an image;
determining, on the basis of detail of image processing that changes a display form of the content, a display form of the symbol image in the content subjected to the image processing; and
indicating addition of the symbol image in the display form determined by the determining to the content subjected to the image processing.
